(19) United States
(12) Patent Application Publication
(10) Pub. No.: US 2020/0153970 A1
(43) Pub. Date: May 14, 2020

(54) CALLING-PARTY IDENTIFIER SELECTION IN A CONTACT CENTER BASED ON PREVIOUS ASSOCIATION WITH A CALLED PARTY

(71) Applicant: Avaya Inc., Basking Ridge, NJ (US)

(72) Inventors: Shamik Shah, Maharashtra (IN); Atul Gaikwad, Maharashtra (IN)

(21) Appl. No.: 16/190,704

(22) Filed: Nov. 14, 2018

(51) Int. Cl. H04M 3/523; H04M 3/42

(52) U.S. Cl. CPC H04M 3/5235; H04M 3/42059; H04M 3/4211

(57) ABSTRACT

The technology disclosed herein enables an improved communication dialer system that uses a calling-party identifier having previous association with a called party to request a communication session with that called party. In a particular embodiment, a method provides identifying a called party for a first communication session and determining a first calling-party identifier from a plurality of calling-party identifiers available to the communication dialer for establishing the first communication session with the called party. The first calling-party identifier was previously used in association with a communication session with the called party. The method further provides directing the communication dialer to request the first communication session with the called party using the first calling-party identifier.

### TECHNICAL BACKGROUND

Contact centers are capable of exchanging communications with many outside parties concurrently. A contact center may use one of many different called party identifiers when calling a called party. For example, the contact center may be allotted many different telephone numbers by a telephone service provider. The contact center uses one of those telephone numbers as the calling number to place a telephone call to a called party. When being notified of the incoming telephone call from the called party, the calling number used by the contact center may be displayed to the called party (as is a standard feature with most modern telephone endpoints). The called party can then determine how they wish to handle the incoming call based on the displayed calling number (e.g., answer the call, ignore the call, or send the call to voicemail).

### SUMMARY

The technology disclosed herein enables an improved communication dialer system that uses a calling-party identifier having previous association with a called party to request a communication session with that called party. In a particular embodiment, a method provides identifying a called party for a first communication session and determining a first calling-party identifier from a plurality of calling-party identifiers available to the communication dialer for establishing the first communication session with the called party. The first calling-party identifier was previously used in association with a communication session with the called party. The method further provides directing the communication dialer to request the first communication session with the called party using the first calling-party identifier.

In some embodiments, determining the first calling-party identifier includes referencing a record for the called party that provides a mapping to the called party of one or more calling-party identifiers of the plurality of calling-party identifiers that were each previously used in association with a successful communication session with the called party and selecting the first calling-party identifier from the one or more calling-party identifiers. In those embodiments, the method may include, prior to the first communication session, determining that a second communication session with the called party using the first calling-party identifier is successful and, in response to determining that the second communication session was successful, adding the first calling-party identifier to the one or more calling-party identifiers. Also, in those embodiments, after determining that the request was unsuccessful, the method may include referencing the record for a number of instances where requests for a communication session with the called party using the first calling-party identifier were also unsuccessful and, upon determining that the number of instances is above a threshold number, removing the first calling-party identifier from the mapping.

In some embodiments, the first calling-party identifier includes one or more of: the one of the plurality of calling-party identifiers that, when used to request a communication session with the called party, resulted in the highest number of established communication sessions, the one of the plurality of calling-party identifiers that, when used to request a communication session with the called party, resulted in a longest duration communication session with the called party, and the one of the plurality of calling-party identifiers that most recently resulted in an established communication session when used to request a communication session with the called party.

In some embodiments, the method includes, after the communication dialer receives a rejection from the called party in response to requesting the first communication session, selecting a second calling-party identifier from the plurality of calling-party identifiers that was previously used in association with a successful communication session with the called party and directing the communication dialer to request the first communication session with the called party using the second calling-party identifier.

In some embodiments, the method includes, after the communication dialer receives a rejection from the called party in response to requesting the first communication session, determining that no other calling-party identifier of the plurality of calling-party identifiers was previously used in association with a successful communication session with the called party and, responsively, randomly selecting a second calling-party identifier from the plurality of calling-party identifiers. The method then provides directing the communication dialer to request the first communication session with the called party using the second calling-party identifier.

In some embodiments, the method includes, after directing the communication dialer to request the first communication session with the called party using the first calling-party identifier, determining that the first calling-party identifier is not available for use with the first communication session. After determining that the first calling-party identifier is not available, waiting a period of time for the first calling-party identifier to become available. If the first calling-party identifier becomes available within the period of time, requesting the first communication session with the called party using the first calling-party identifier. If the first calling-party identifier does not become available within the period of time, determining a second calling-party identifier from the plurality of calling-party identifiers and directing the communication dialer to request the first communication session with the called party using the second calling-party identifier.

In some embodiments, each of the plurality of calling-party identifiers comprises a telephone number and the first calling-party identifier comprises one of the calling-party identifiers that was used by the called party to contact the contact center in a previous communication session.

In some embodiments, determining a first calling-party identifier includes receiving input, from an agent of the contact center, comprising an instruction for the communication dialer to use the first calling-party identifier for communication sessions with the called party.

In another embodiment, an apparatus is provided having one or more computer readable storage media and a processing system operatively coupled with the one or more computer readable storage media. Program instructions stored on the one or more computer readable storage media that, when read and executed by the processing system, direct the processing system to identify a called party for a first communication session and determine a first calling-party identifier from a plurality of calling-party identifiers available to the communication dialer for establishing the first communication session with the called party. The first calling-party identifier was previously used in association with a communication session with the called party. The program instructions further direct the processing system to direct the communication dialer to request the first communication session with the called party using the first calling-party identifier.

### BRIEF DESCRIPTION OF THE DRAWINGS

FIG. 1 illustrates an implementation for determining a calling identifier to use for a communication session with a called party.

FIG. 2 illustrates an operation to determine a calling identifier to use for a communication session with a called party.

FIG. 3 illustrates another implementation for determining a calling identifier to use for a communication session with a called party.

FIG. 4 illustrates a scenario for determining a calling identifier to use for a communication session with a called party.

FIG. 5 illustrates another scenario for determining a calling identifier to use for a communication session with a called party.

FIG. 6 illustrates yet another scenario for determining a calling identifier to use for a communication session with a called party.

FIG. 7 illustrates one more scenario for determining a calling identifier to use for a communication session with a called party.

FIG. 8 illustrates a computing architecture for determining a calling identifier to use for a communication session with a called party.

### DETAILED DESCRIPTION

A communication dialer system is tasked with initiating out-bound communications from a contact center. The communication dialer may have any number of calling-party identifiers that may be used when establishing outbound communications to called parties. Traditionally, these calling-party identifiers would be telephone numbers used for traditional voice calls. However, many newer modes of communications use other types of identifiers for parties to a communication. For example, instant messaging, packet-based voice/video communications, social networking, may use usernames, handles, email addresses, etc. to identify parties to a communication. A communication dialer using any of these newer modes of communications may have a number of these other types of calling-party identifiers available to use when placing outgoing communications.

Since it is very likely that the communications endpoint (e.g., smartphone, personal computer, etc.) is going to display the calling-party identifier used for an incoming communication, the calling-party identifier may affect whether the called party answers or otherwise chooses to participate in the communication. In a general sense, a user is more likely to participate in an incoming communication when the communication identifies itself using a calling-party identifier that the called party recognizes. As such, the communication dialer systems herein select a calling-party identifier that called parties are likely to recognize, which increases the chances that a called party will participate in an incoming communication.

For example, in a marketing/sales campaign, a contact center may dial a customer and the customer shows interest in the product to an agent but asks the agent to call back at a later time. The probability that the customer will answer when the agent calls back increases if the contact center dialer uses the same number as was used to reach out to the customer during the previous call. Similarly, when a contact center performs multiple follow-ups with a customer for any reason, the customer typically will expect calls from the same number and will, therefore, be more likely to answer the calls. Moreover, in many cases, a customer will save a particular phone number of the contact center if that phone number was used during a productive conversation. If the contact center calls again using that same number, the saved name associated with that number will be presented to the customer rather than some other number that the customer may simply assume is not associated with the contact center (or anyone else in the customer's contacts). In any of the above examples, the contact center's resources are betting utilized due to not being wasted attempting to establish communications with customers that do not end up being answered by the customer or otherwise productive.

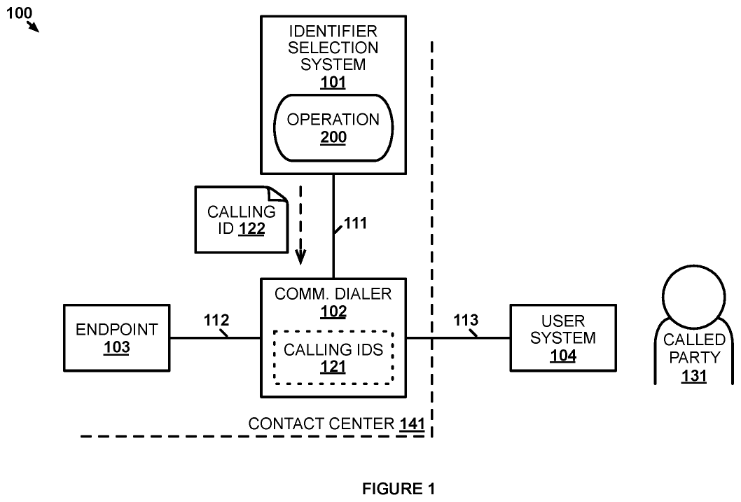

FIG. 1 illustrates implementation 100 for determining a calling identifier to use for a communication session with a called party. Implementation 100 includes identifier selection system 101, communication dialer system 102, endpoint system 103, and user system 104. Identifier selection system 101 and communication dialer system 102 communicate over communication link 111. Identifier selection system 101, communication dialer system 102, and endpoint system 103 are part of contact center 141. Communication dialer system 102 and endpoint system 103 communicate over communication link 112. Communication dialer system 102 and user system 104 communicate over communication link 113. Communication links 111-113 comprise wireless and/or wired communication links, which may be direct links or may include intervening systems, devices, and/or networks, including the Internet.

In operation, communication dialer system 102 handles the establishment of outgoing communications from contact center 141. The outgoing communications are established between user systems operated by respective called parties and one or more endpoint systems, such as endpoint system 103. Endpoint system 103 may be a user system (e.g., telephone, tablet, personal computer, etc.) operated by an agent of contact center 141, an interactive voice response system, an automated messaging system, or some other type of endpoint that may be used within a contact center environment. Contact center 141 may include any combination of different endpoint system types for which communication dialer system 102 handles the establishment of outgoing communication sessions.

Communication dialer system 102 has calling-party identifiers 121 at its disposal to use when placing those outgoing communications. Rather than arbitrarily selecting one of calling-party identifiers 121, identifier selection system 101 instructs communication dialer system 102 to use a particular calling-party identifier. The particular calling-party identifier is one that identifier selection system 101 determines is more likely to result in a successful communication session with the party being called. While identifier selection system 101 is shown in a separate system, in some examples, the calling-party identifier selection features of identifier selection system 101 may be incorporated into communication dialer system 102 or some other system of contact center 141.

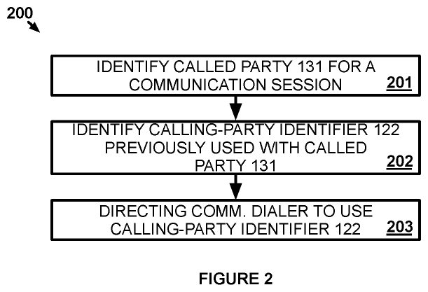

FIG. 2 illustrates operation 200 to determine a calling identifier to use for a communication session with a called party. Operation 200 is performed by identifier selection system 101 to determine a calling-party identifier that communication dialer system 102 should be used by communication dialer system 102 when attempting to establish a communication session with a user system operated by a particular called party. In operation 200, identifier selection system 101 identifies called party 131 with which communication dialer system 102 should attempt to establish a communication session (201). Called party 131 may be identified automatically by identifier selection system 101, may be identified in a message from endpoint system 103, may be identified in a message from communication dialer system 102, or may be identified in some other manner. In some examples, called party 131 may be identified by a called-party identifier for called party 131 or user system 104. A called-party identifier, like a calling-party identifier, may be a telephone number, username, email address, messaging/social network handle, or some other unique identifier that communication dialer system 102 can use to direct a communication session to called party 131. In some examples, called party 131 may be identified by name and identifier selection system 101 may have access to information that maps names to called-party identifiers for respective called parties.

Once called party 131 is identified, identifier selection system 101 determines calling-party identifier 122 of calling-party identifiers 121 should be used by communication dialer system 102 to establish a communication session with called party 131 (202). In general, calling-party identifier 122 is a calling-party identifier of calling-party identifiers 121 that was previously used in association with a communication session with called party 131. Calling-party identifier 122 may have been used either to establish a communication session from contact center 141 to contact center 141 or may have been used by called party 131 to establish a communication session to contact center 141. Essentially, using calling-party identifier 122 increases the chances that called party 131 will recognize an incoming communication session request as being from contact center 141 and choose to participate in the incoming communication session accordingly. In some examples, a calling-party identifier may not only need to be associated with a previous communication session with called party 131 but that previous communication session must also have been a successful one (e.g., a communication that did not result in a quick hang up by called party 131). Identifier selection system 101 may maintain, or otherwise have access to, communication session records that at least indicate one or more of calling-party identifiers 121, including calling-party identifier 122, that have been used previously for communication sessions with called party 131. Identifier selection system 101 may therefore select calling-party identifier 122 from those records.

Upon identifying calling-party identifier 122, identifier selection system 101 directs communication dialer system 102 to request a communication session with called party 131 using calling-party identifier 122 (203). In some examples, identifier selection system 101 may further identify called party 131 to communication dialer system 102 such that communication dialer system 102 knows who should be contacted using calling-party identifier 122. Communication dialer system 102 can then perform whatever steps are typically necessary to request a communication session with called party 131. For some communication types, a request causes a notification (e.g., a ring, vibration, and/or display notifier to occur at user system 104) of an incoming real-time communication that called party 131 has the option of accepting. Such requests include a traditional voice call, or other voice/video communication type having a similar procedure, ringing at user system 104. In other examples, such as instant messaging or email, the request may itself be a message (e.g., “Hello called party 131, this is contact center 141, do you have a second to chat?”) that called party 131 can respond to in order to participant in the communication session. In this example, communication dialer system 102 transfers a communication session request to user system 104, which is operated by called party 131. While only user system 104 is shown in association with called party 131 for this example, it should be understood that some types of communication sessions are capable of contacting multiple user systems when attempting to establish a communication session. As such, when communication dialer system 102 requests a communication session with called party 131, the request may be transferred to multiple user systems associated with called party 131. For example, called party 131 may be logged into their instant messaging account on multiple user systems, including user system 104. When communication dialer system 102 transfers a request to establish a communication session, that request may be transferred to all of the multiple user systems, not just user system 104, as is the focus of this example.

When the request is received by user system 104, user system 104 may display or audibly present calling-party identifier 122 to called party 131 to identify the source of the request. In examples where user system 104 the incoming communications session request causes user system 104 to “ring” or similarly notify called party 131, user system 104 may further present calling-party identifier 122 to identify the calling-party to called party 131. In examples where the communication session request comprises a message to called party 131 (e.g., an instant message or email), the message may be presented by user system 104 as coming from calling-party identifier 122. In some cases, called party 131 may have saved calling-party identifier 122 as being associated with contact center 141 in a contacts list. In those cases, user system 104 may also, or instead, explicitly present that the incoming communication session request is from contact center 141, or whatever name called party 131 gave to contact center 141 in the contacts list. Regardless, since calling-party identifier 122 was associated with a previous communication session with called party 131, called party 131 will likely be able to make a more informed decision about whether called party 131 wishes to participate in a communication session with contact center 141.

In some examples, communication dialer system 102 may connect the communication session to endpoint system 103 upon called party 131 accepting the incoming communication session request (e.g., called party 131 answers the communication session request or responds to a message requesting the communication session). In other examples, communication dialer system 102 may connect the communication session to endpoint system 103 before called party 131 accepts so as to reduce the chance of delay for endpoint system 103, or any human operator at endpoint system 103, joining the communication session.

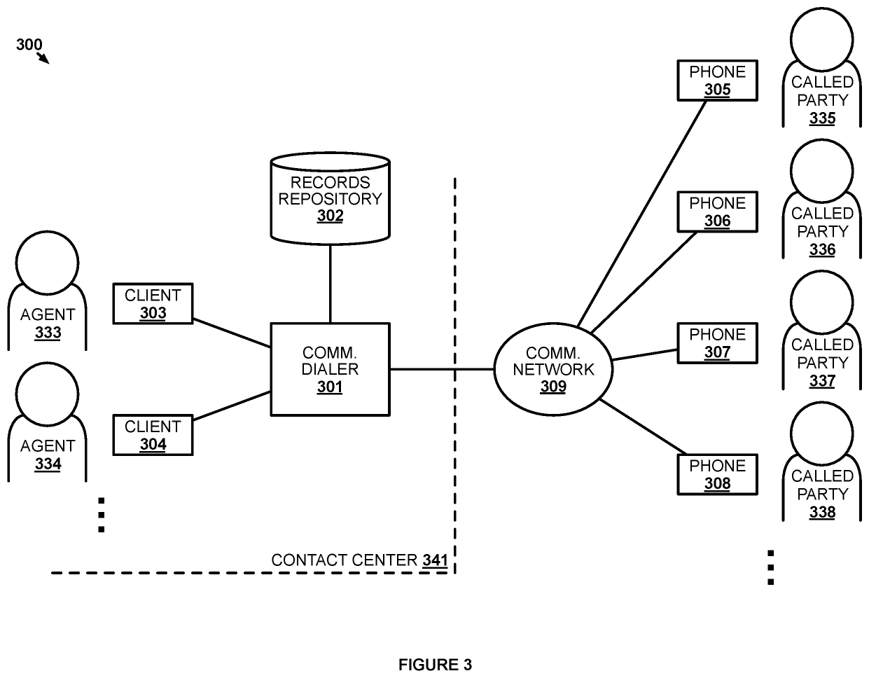

FIG. 3 illustrates implementation 300 for determining a calling identifier to use for a communication session with a called party. Implementation 300 includes communication dialer system 301, records repository 302, agent client system 303, agent client system 304, telephone 305, telephone 306, telephone 307, telephone 308, and communication network 309. Communication dialer system 301, records repository 302, agent client system 303, and agent client system 304 are considered part of contact center 341 and may be co-located or distributed in different geographic locations and may also communicate over communication network 309.

In operation, contact center 341 staffs agents, including agent 333 and agent 334, for communicating with parties outside of contact center 341, including called party 335, called party 336, called party 337, and called party 338. In this example, communications between agents 333-334 and called parties 335-338 comprise voice communications that are established by dialing a telephone number. As such, telephones 305-308 may be reached by communication dialer system 301 dialing their respective telephone numbers and connecting over one or more packet, circuit switched, cellular, or other type of network. In this example, agent 333 and agent 334 operate agent client system 303 and agent client system 304, respectively, which have the capability to exchange voice communications with telephones 305-308. In some cases, communication dialer system 301, or some other system in contact center 341, may act as a bridge for communications between the telephone network. In other examples, agent client system 303 and agent client system 304 may be telephones themselves and not require any sort of bridging.

Communication dialer system 301 has many different telephone numbers that it can use when dialing a voice call to an outside telephone. When one of telephones 305-308 receives a call from communication dialer system 301, the telephone number used by communication dialer system 301 for that call may be displayed so that the called party can identify the caller from that calling telephone number. Communication dialer system 301 determines which of the telephone numbers should be used on an individual basis for each called party by accessing called-party records stored in records repository 302.

Records repository 302 is a storage system having computer readable storage media, such as hard disk drives, solid state drives, or other type of memory apparatus, for storing data accessible by communication dialer system 301. As such, records repository 302 may further including processing and communication interface circuitry necessary for communication dialer system 301 to access the data stored therein. Records repository 302 at least stores information that maps particular ones of the telephone numbers available to communication dialer system 301 to respective called parties 335-338. The mapping may indicate numbers that have been used for calls with a called party and may indicate statistics about those numbers (e.g., how many times each number was used with the called party, whether calls were successful when a number was used, etc.). Communication dialer system 301 uses the mapping information to determine which telephone number should be used as the calling number when communication dialer system 301 initiates a communication session with a particular called party, as described in more detail below.

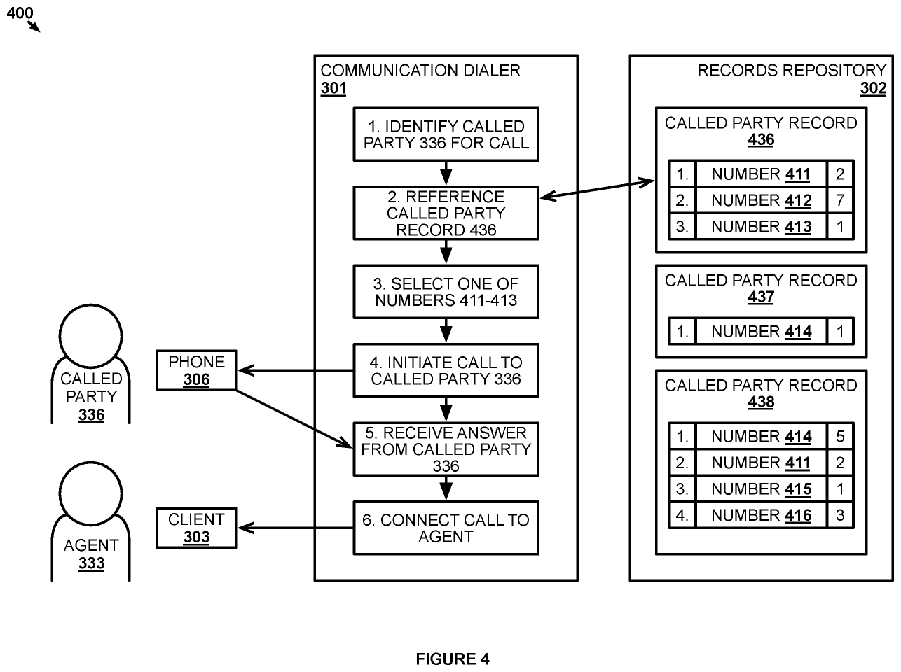

FIG. 4 illustrates scenario 400 for determining a calling identifier to use for a communication session with a called party. Scenario 400 is an example of how implementation 300 may operate to request an outgoing communication session with called party 336. Communication dialer system 301 identifies called party 336 at step 1 to which communication dialer system 301 should dial a call. Communication dialer system 301 may maintain a list of called parties that are due to receive calls from an agent of contact center 341, may receive an instruction from agent 333 to dial called party 336, or may determine that called party 336 should be called for some other reason.

After identifying called party 336, communication dialer system 301 accesses records repository 302 to reference called party record 436, which is the called party record for called party 336, at step 2 to determine whether any of the phone numbers available for communication dialer system 301 to use are associated with called party 336. In this example, called party record 436 indicates that phone number 411, phone number 412, and phone number 413 are all associated with called party 336. Records repository 302 further includes called party record 437 for called party 337 and called party record 438 for called party 338, although those two records are not needed when communication dialer system 301 is concerned with called party 336. Called party record 437 and called party record 438 will instead be referenced when communication dialer system 301 identifies called party 337 and called party 338, respectively, for dialing a call. As can be seen in called party record 436, called party record 437, and called party record 438, more than one called party can be associated with the same phone number. In this example, both called party record 436 and called party record 438 map phone number 411 to called party 336 and called party 338, respectively. Likewise, both called party record 437 and called party record 438 map phone number 414 to called party 337 and called party 338, respectively.

From referencing called party record 436, communication dialer system 301 selects one of phone number 411, phone number 412, and phone number 413 at step 3 for dialing a call to called party 336. In some examples, communication dialer system 301 may simply select one of phone number 411, phone number 412, or phone number 413 at random. However, in other examples, communication dialer system 301 may consider further factors when determining which number to select. For example, each of called party records 436-438 indicate how recent each phone number therein was used as illustrated by the order in which the phone numbers are listed in each called party record. Called party record 436 indicates that phone number 411 was used most recently and is followed by phone number 412 as the next most recently used phone number. Phone number 413 is the third most recently used phone number according to called party record 436. Called party records 437 and 438 similarly indicate how recently each phone number was used in association with calls between contact center 341 and their respective called parties 337 and 338. Communication dialer system 301 may therefore be configured to select the most recently used phone number, phone number 411 in this case, to use as the calling phone number when dialing out to called party 336.

Alternatively, communication dialer system 301 may be configured to select a most used one of the phone numbers associated with called party 336. Each call record indicates a number of times each phone number was used in association with a call between contact center 341 and called party 336. Phone number 411 has been used twice, phone number 412 has been used seven times, and phone number 413 has been used once. Even though phone number 411 was used most recently, communication dialer system 301 may instead select the most used phone number, which is phone number 412 in this case. In some cases, communication dialer system 301 may operate under rules that indicate when the most recent phone number should be used or when the most used phone number should be used. For instance, the rules may instruct communication dialer system 301 to select the most recently used phone number unless there is another phone number that has been used five or more times more than the most recently used phone number. In that instance, phone number 412 would be selected over phone number 411.

In other examples, additional statistics may be maintained within called party records 436-438 that can be used by communication dialer system 301 for determining which phone number should be selected. For example, called party record 436 may indicate duration statistics for calls established using each of phone number 411, phone number 412, and phone number 413. The duration statistics may indicate the average duration of calls using each phone number, a longest duration call for each phone number, or some other duration related statistic. Communication dialer system 301 may then be able to select a phone number based on the duration statistics (e.g., selecting the phone number that was used during the longest duration call). Other types of statistics may be used in other examples, such as maintaining a time of day each phone number was used so communication dialer system 301 can select a phone number that was also used for a call during a similar time.

In further examples, an agent of contact center 341 may explicitly indicate what number should be used when calling called party 336. The agent may provide the indication when instructing communication dialer system 301 to place a call to called party 336 or may provide the indication at some other time before the call is placed. This indication may override any other criteria, such as the criteria discussed above, that communication dialer system 301 would otherwise follow when selecting a calling-party phone number.

Once a phone number has been selected for communication dialer system 301 to use as the calling party phone number, communication dialer system 301 dials a phone number for called party 336, which is a phone number of telephone 306 in this case, to initiate a call to called party 336 at step 4. If communication dialer system 301 selected phone number 411, then telephone 306 will notify called party 336 that an incoming call is being received from phone number 411. When called party 336 chooses to answer the call, communication dialer system 301 receives an indication at step 5 that the call has been answered at telephone 306 (e.g., recognizes that the call is no longer ringing but has been connected). Communication dialer system 301 then connects the call through to agent client system 303 at step 6 so agent 333 can participate in a voice communication with called party 336 over the voice call with telephone 306 and agent client system 303 as endpoints.

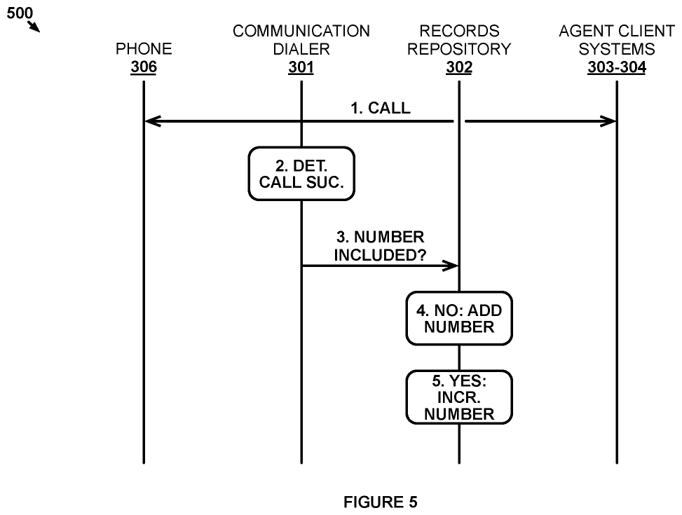

FIG. 5 illustrates scenario 500 for determining a calling identifier to use for a communication session with a called party. Scenario 500 is an example of how a phone number may be added to a called party record for a called party. In this example, a call occurs at step 1 between telephone 306 and one of agent client system 303 and agent client system 304. The call may have been initiated by communication dialer system 301 or by telephone 306 at the instruction of called party 336. Communication dialer system 301 determines whether the call is successful at step 2. A call may be considered successful if the call lasted longer than a threshold duration, if an agent indicates to communication dialer system 301 through their agent client system that the call was successful, if called party 336 indicates the call was successful (e.g., through a survey from contact center 341 post call), or via some other indication. If the call is determined to not be successful, then communication dialer system 301 does not do anything with the number used by communication dialer system 301 on the call (i.e., the calling number used for communication dialer system 301 to dial out or the number used by telephone 306 to dial into contact center 341).

However, upon communication dialer system 301 determining that the call was successful, communication dialer system 301 checks with records repository 302 to determine at step 3 whether a called party record for called party 336, called party record 436 in this case, includes the number used by communication dialer system 301 on the call. If the number used by communication dialer system 301 is not already in called party record 436, then communication dialer system 301 adds the number to called party record 436 at step 4 and indicates that the number was used for one successful call. In some cases, a called party record may not yet exist (e.g., there is no called party record in records repository 302 for called party 335, either because called party 335 had not yet communicated with contact center 341 or because called party 335 had not yet participated in a successful call with contact center 341). In those examples, communication dialer system 301 may then create called party record 436 before adding the number thereto. Alternatively, if the number used by communication dialer system 301 is already in called party record 436, then communication dialer system 301 merely increments the number of times the number has been used in called party record 436 at step 5. For example, if the number is phone number 411, then the number of times phone number 411 has been used will be incremented from two to three.

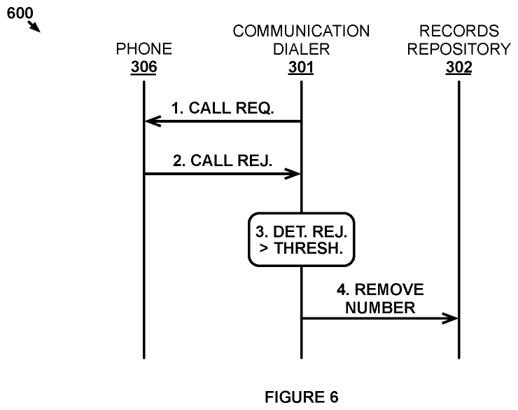

FIG. 6 illustrates scenario 600 for determining a calling identifier to use for a communication session with a called party. In scenario 600, called party records further track and indicate a number of call request rejections for phone numbers used when attempting to request a call. At step 1, communication dialer system 301 requests a call by dialing telephone 306 from phone number 413. Communication dialer system 301 then recognizes at step 2 that the call was rejected or was otherwise unsuccessful. For instance, the call may not have been answered within a threshold amount of time, the call may have been sent to voicemail, the call may have been answered but did not last a threshold duration to be considered successful, or the call may have met some other criteria for not qualifying as a successful call. Upon the call being rejected, communication dialer system 301 determines at step 3 whether a number of rejections is greater than a threshold number of rejections in called party record 436. If the number of rejections is above the threshold, communication dialer system 301 removes the calling party number used to place the call from called party record 436 so that it is no longer an option for communication dialer system 301 to use in the future when determining which calling party number to use. Alternatively, if the threshold is not met, then communication dialer system 301 increments the number of rejections indicated in called party record 436 for that particular number.

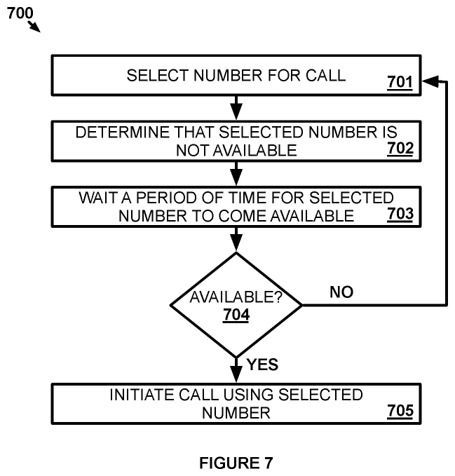

FIG. 7 illustrates scenario 700 for determining a calling identifier to use for a communication session with a called party. In this example, communication dialer system 301 is only able to use a calling number for one call at a time whereas, in other examples, communication dialer system 301 may be able to use the same number to place multiple calls at the same time. In scenario 700, communication dialer system 301 selects a phone number to use as a calling-party phone number in one of the manners discussed above (701). Before placing the call, however, communication dialer system 301 determines that the selected phone number is being used for another call (702). Communication dialer system 301 therefore waits a predefined period of time for the other call to end so that the selected number can be used for the new call (703). During the period of time, communication dialer system 301 determines whether the selected number becomes available (704). Upon the number coming available, communication dialer system 301 initiates a call using the selected number (705). If, however, the period of time elapses without the selected number becoming available, communication dialer system 301 returns to step 702 to select a new number.

For example, if communication dialer system 301 is dialing called party 336, then communication dialer system 301 may initially select phone number 411 to use as the calling-party phone number for the call. However, phone number 411 may currently be used for a call with called party 338 since phone number 411 is also listed in called party record 438 of called party 338. Thus, if phone number 411 does not become available within the predefined period of time, then communication dialer system 301 may select phone number 412 instead. In some cases, none of the selected numbers from called party record 436 end up being available and then communication dialer system 301 may default to selecting some other number that is available for use even though it is not a number in called party record 436.

It should be understood that, while the examples above discuss phone numbers in the context of implementation 300, the same teachings may apply to other type of calling-party identifiers.

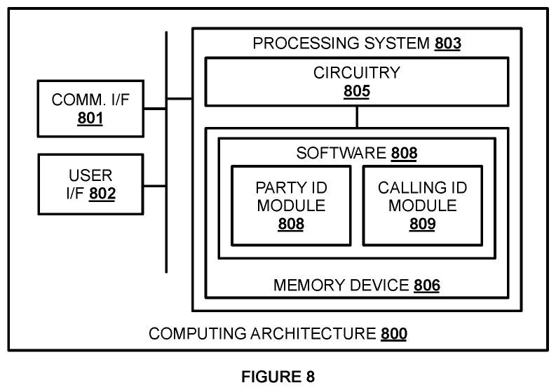

FIG. 8 illustrates computing architecture 800 for determining a calling identifier to use for a communication session with a called party. Computing architecture 800 is an example computing architecture for identifier selection system 101 and communication dialer system 301, although systems 101 and 301 may use alternative configurations. A similar architecture may also be used for other systems described herein, although alternative configurations may also be used. Computing architecture 800 comprises communication interface 801, user interface 802, and processing system 803. Processing system 803 is linked to communication interface 801 and user interface 802. Processing system 803 includes processing circuitry 805 and memory device 806 that stores operating software 807.

Communication interface 801 comprises components that communicate over communication links, such as network cards, ports, RF transceivers, processing circuitry and software, or some other communication devices. Communication interface 801 may be configured to communicate over metallic, wireless, or optical links. Communication interface 801 may be configured to use TDM, IP, Ethernet, optical networking, wireless protocols, communication signaling, or some other communication format—including combinations thereof.

User interface 802 comprises components that interact with a user. User interface 802 may include a keyboard, display screen, mouse, touch pad, or some other user input/output apparatus. User interface 802 may be omitted in some examples.

Processing circuitry 805 comprises microprocessor and other circuitry that retrieves and executes operating software 807 from memory device 806. Memory device 806 comprises a storage medium, such as a disk drive, flash drive, data storage circuitry, or some other memory apparatus. In no examples would memory device 806 be considered a propagated signal. Operating software 807 comprises computer programs, firmware, or some other form of machine-readable processing instructions. Operating software 807 includes communication called-party identification module 808 and calling-party identifier determination module 809. Operating software 807 may further include an operating system, utilities, drivers, network interfaces, applications, or some other type of software. When executed by processing circuitry 805, operating software 807 directs processing system 803 to operate computing architecture 800 as described herein.

In particular, called-party identification module 808 directs processing system 803 to identify a called party for a first communication session. Calling-party identifier determination module 809 directs processing system 803 to determine a first calling-party identifier from a plurality of calling-party identifiers available to a communication dialer for establishing the first communication session with the called party. The first calling-party identifier was previously used in association with a communication session with the called party. Calling-party identifier determination module 809 further directs processing system 803 to direct the communication dialer to request the first communication session with the called party using the first calling-party identifier.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

1. A method for improving calling-party identifier selection by a communication dialer of a contact center, the method comprising:
identifying a called party for a first communication session;
determining a first calling-party identifier from a plurality of calling-party identifiers available to the communication dialer for establishing the first communication session with the called party, wherein the first calling-party identifier was previously used in association with a communication session between the contact center and with the called party; and
directing the communication dialer to request the first communication session with the called party using the first calling-party identifier.

2. The method of claim 1, wherein determining the first calling-party identifier comprises:
referencing a record for the called party that provides a mapping to the called party of one or more calling-party identifiers of the plurality of calling-party identifiers that were each previously used in association with a successful communication session with the called party; and
selecting the first calling-party identifier from the one or more calling-party identifiers.

3. The method of claim 2, further comprising:
prior to the first communication session, determining that a second communication session with the called party using the first calling-party identifier is successful; and
in response to determining that the second communication session was successful, adding the first calling-party identifier to the one or more calling-party identifiers.

4. The method of claim 2, further comprising:
after determining that the request was unsuccessful, referencing the record for a number of instances where requests for a communication session with the called party using the first calling-party identifier were also unsuccessful; and
upon determining that the number of instances is above a threshold number, removing the first calling-party identifier from the mapping.

5. The method of claim 1, wherein the first calling-party identifier comprises one or more of:
the one of the plurality of calling-party identifiers that, when used to request a communication session with the called party, resulted in the highest number of established communication sessions;
the one of the plurality of calling-party identifiers that, when used to request a communication session with the called party, resulted in a longest duration communication session with the called party; and
the one of the plurality of calling-party identifiers that most recently resulted in an established communication session when used to request a communication session with the called party.

6. The method of claim 1, further comprising:
after the communication dialer receives a rejection from the called party in response to requesting the first communication session, selecting a second calling-party identifier from the plurality of calling-party identifiers that was previously used in association with a successful communication session with the called party; and
directing the communication dialer to request the first communication session with the called party using the second calling-party identifier.

7. The method of claim 1, further comprising:
after the communication dialer receives a rejection from the called party in response to requesting the first communication session, determining that no other calling-party identifier of the plurality of calling-party identifiers was previously used in association with a successful communication session with the called party and, responsively, randomly selecting a second calling-party identifier from the plurality of calling-party identifiers; and
directing the communication dialer to request the first communication session with the called party using the second calling-party identifier.

8. The method of claim 1, further comprising:
after directing the communication dialer to request the first communication session with the called party using the first calling-party identifier, determining that the first calling-party identifier is not available for use with the first communication session; and
after determining that the first calling-party identifier is not available, waiting a period of time for the first calling-party identifier to become available;
if the first calling-party identifier becomes available within the period of time, requesting the first communication session with the called party using the first calling-party identifier; and
if the first calling-party identifier does not become available within the period of time, determining a second calling-party identifier from the plurality of calling-party identifiers and directing the communication dialer to request the first communication session with the called party using the second calling-party identifier.

9. The method of claim 1, wherein each of the plurality of calling-party identifiers comprises a telephone number and the first calling-party identifier comprises one of the calling-party identifiers that was used by the called party to contact the contact center in a previous communication session.

10. The method of claim 1, wherein determining the first calling-party identifier comprises:
receiving input, from an agent of the contact center, comprising an instruction for the communication dialer to use the first calling-party identifier for communication sessions with the called party.

11. An apparatus for improving calling-party identifier selection by a communication dialer of a contact center, the apparatus comprising:
one or more computer readable storage media;
a processing system operatively coupled with the one or more computer readable storage media; and
program instructions stored on the one or more computer readable storage media that, when read and executed by the processing system, direct the processing system to:
identify a called party for a first communication session;
determine a first calling-party identifier from a plurality of calling-party identifiers available to the communication dialer for establishing the first communication session with the called party, wherein the first calling-party identifier was previously used in association with a communication session between the contact center and the called party; and
direct the communication dialer to request the first communication session with the called party using the first calling-party identifier.

12. The apparatus of claim 11, wherein to determine the first calling-party identifier, the program instructions direct the processing system to:
reference a record for the called party that provides a mapping to the called party of one or more calling-party identifiers of the plurality of calling-party identifiers that were each previously used in association with a successful communication session with the called party; and
select the first calling-party identifier from the one or more calling-party identifiers.

13. The apparatus of claim 12, wherein the program instructions further direct the processing system to:
prior to the first communication session, determine that a second communication session with the called party using the first calling-party identifier is successful; and
in response to determining that the second communication session was successful, add the first calling-party identifier to the one or more calling-party identifiers.

14. The apparatus of claim 12, wherein the program instructions further direct the processing system to:
after determining that the request was unsuccessful, reference the record for a number of instances where requests for a communication session with the called party using the first calling-party identifier were also unsuccessful; and
upon determining that the number of instances is above a threshold number, remove the first calling-party identifier from the mapping.

15. The apparatus of claim 11, wherein the first calling-party identifier comprises one or more of:
the one of the plurality of calling-party identifiers that, when used to request a communication session with the called party, resulted in the highest number of established communication sessions;
the one of the plurality of calling-party identifiers that, when used to request a communication session with the called party, resulted in a longest duration communication session with the called party; and
the one of the plurality of calling-party identifiers that most recently resulted in an established communication session when used to request a communication session with the called party.

16. The apparatus of claim 11, wherein the program instructions further direct the processing system to:
after the communication dialer receives a rejection from the called party in response to requesting the first communication session, select a second calling-party identifier from the plurality of calling-party identifiers that was previously used in association with a successful communication session with the called party; and
direct the communication dialer to request the first communication session with the called party using the second calling-party identifier.

17. The apparatus of claim 11, wherein the program instructions further direct the processing system to:
after the communication dialer receives a rejection from the called party in response to requesting the first communication session, determine that no other calling-party identifier of the plurality of calling-party identifiers was previously used in association with a successful communication session with the called party and, responsively, randomly select a second calling-party identifier from the plurality of calling-party identifiers; and
direct the communication dialer to request the first communication session with the called party using the second calling-party identifier.

18. The apparatus of claim 11, wherein the program instructions further direct the processing system to:
after directing the communication dialer to request the first communication session with the called party using the first calling-party identifier, determine that the first calling-party identifier is not available for use with the first communication session; and
after determining that the first calling-party identifier is not available, wait a period of time for the first calling-party identifier to become available;
if the first calling-party identifier becomes available within the period of time, request the first communication session with the called party using the first calling-party identifier; and
if the first calling-party identifier does not become available within the period of time, determine a second calling-party identifier from the plurality of calling-party identifiers and direct the communication dialer to request the first communication session with the called party using the second calling-party identifier.

19. The apparatus of claim 11, wherein each of the plurality of calling-party identifiers comprises a telephone number and the first calling-party identifier comprises one of the calling-party identifiers that was used by the called party to contact the contact center in a previous communication session.

20. One or more computer readable storage media having program instructions stored thereon for improving calling-party identifier selection by a communication dialer of a contact center, the program instructions, when reached and executed by a processing system, direct the processing system to:
identify a called party for a first communication session;
determine a first calling-party identifier from a plurality of calling-party identifiers available to the communication dialer for establishing the first communication session with the called party, wherein the first calling-party identifier was previously used in association with a communication session between the contact center and with the called party; and
direct the communication dialer to request the first communication session with the called party using the first calling-party identifier.
